(19) United States
(12) Patent Application Publication
(10) Pub. No.: US 2016/0187716 A1
(43) Pub. Date: Jun. 30, 2016

(54) Liquid crystal panel and liquid crystal display

(71) Applicant: Shenzhen China Star Optoelectronics Technology Co. Ltd., Shenzhen, Guangdong (CN)

(72) Inventors: Tao SONG, Shenzhen, Guangdong (CN); Zhiyuan SHEN, Shenzhen, Guangdong (CN); Xing MING, Shenzhen, Guangdong (CN)

(73) Assignee: Shenzhen China Star Optoelectronics Technology Co. Ltd., Shenzhen, Guangdong (CN)

(21) Appl. No.: 14/433,665

(22) PCT Filed: Jan. 28, 2015
(86) PCT No.: PCT/CN2015/071706

§ 371 Date: Apr. 4, 2015

(30) Foreign Application Priority Data
Dec. 30, 2014 (CN) 2014108508642

(51) Int. Cl. G02F 1/1335

(52) U.S. Cl. CPC G02F 1/133512

(57) ABSTRACT

The disclosure provides a liquid crystal panel and a liquid crystal display. The liquid crystal panel comprises a first substrate, a second substrate, a liquid crystal layer and a light blocking layer. The second substrate is disposed opposite to the first substrate. The liquid crystal layer is clamped between the first substrate and the second substrate. The light blocking layer is disposed at the first substrate. The light blocking layer is disposed at the narrow frame of the non-display section for preventing light leaking from the edge of the liquid crystal panel. Therefore, the disclosure can prevent light leaking from the edge of the liquid crystal panel so that the visual quality is improved.

### BACKGROUND

1. Technical Field

The disclosure relates to the liquid crystal display field, and more particularly, to a liquid crystal panel and a liquid crystal display.

2. Related Art

In the industry of flat panel displays, the frame of the devices has become thinner and thinner. More specifically, for portable displays, such as cell phones, tablet PCs, the frame of those devices has become thinner and thinner. In addition, the industry tried to manufacture those devices without frames. Thereby, the usage of the devices is increased, and the visual effect of the devices is improved.

At present, the mainstream liquid displays are consisted of a LCD (liquid Crystal Display) and a backlight. The amount of light leaving from the backlight and passing through the liquid crystal layer is adjusted according to the index of refraction and anisotropy of the liquid crystal molecules. Thus, the expected image is displayed on the screen.

The top cover is used for preventing the backlight spreading out form the edge of the LCD, which may cause the loss of the brightness of the backlight and the interference to people's eyes. However, as accompanied with the development of thin frames, the frame of the LCD (the region between the edge of the display section and the edge of the LCD) and the frame of the cover have become thinner and thinner. Currently, the width can be 1 mm or even smaller than 1 mm. When the size of the edge of the top cover is smaller, the ability of preventing light leaking is worse. Besides, LCD displays are mainly assembled by a backlight, a LCD and a top cover, and the tolerances is around ±0.2 mm, so that it is more probable to leak light. Therefore, risk of leaking light for the products with a thinner width would become higher and higher.

Besides, in order to precisely control the accuracy and the quality of the edge of the products, as shown in Fig. a of FIG. 1, the edge of the LCD is designed to include a clean glass section 11, in some cases, the width of the clean glass section 11 is even greater. Opaque images are not allowed to be existed at the clean glass section 11. Thereby, the accuracy and the quality of the LCD can be monitored through the clean glass section 11. If all the clean glass section 11 is covered by BM, then BM would interfere the accuracy and the quality of the LCD. Since the clean glass section 11 is transparent, the backlight can pass through the clean glass section 11, which leads to light leaking, and further makes it more difficult to cover the leaked light for the top cover.

In order to solve the problem of light leaking from the edge of LCD display modules, as shown in Fig. b in FIG. 1, the industry provides a method that: a black tape is sticked to the edge of the backlight or the back of the LCD display so as to prevent light leaking. However, an additional process is necessary to stick the black tape onto the device. Additionally, the accuracy of sticking the black tape makes the process more complicated, in which many problems occur. Specifically, the probability of leaking light at the non-terminal section is even higher.

### SUMMARY

According to the above problems, the disclosure provides a liquid crystal panel and a liquid crystal display so as to prevent light leaking from the edge and to improve visual quality.

In order to accomplish the above purpose, one embodiment of the disclosure provides a liquid crystal panel, wherein the crystal panel is divided into a display section and a non-display section, the non-display section is disposed outside the display section. The non-display section surrounds the display section. The liquid crystal panel comprises a first substrate, a second substrate, a liquid crystal layer, and a light blocking layer. The second substrate is disposed opposite to the first substrate. The liquid crystal layer is clamped between the first substrate and the second substrate. The light blocking layer is disposed at the first substrate, wherein the light blocking layer is disposed at the narrow frame of the non-display section for preventing light leaking from the edge of the liquid crystal panel.

Wherein, the non-display section comprises a black matrix section, a terminal section and a non-terminal section. The terminal section is disposed at the section of the liquid crystal panel having a greater width. The black matrix section is disposed outside the display section. The black matrix section surrounds the display section. The rest section of the non-display section is the non-terminal section. The non-terminal section is the narrow frame of the liquid crystal panel.

Wherein, the light blocking layer is disposed at the non-terminal section of the non-display section.

Wherein, the second substrate comprises a clean glass section disposed at the section corresponding to the non-display section.

Wherein, the light blocking layer adopts the metallic layer 1 in the five photomask process of TFT.

Wherein, the light blocking layer adopts the metallic layer 2 in the five photomask process of TFT.

Wherein, the light blocking layer adopts a-Si, LTPS, or the metallic layer in the TFT process of IGZO technique.

Wherein, the light blocking layer adopts the thin film in the on cell touch technique.

Wherein, the light blocking layer is capable of protecting the liquid crystal panel from static electricity.

In order to accomplish the above purpose, another embodiment of the disclosure provides a liquid crystal display, wherein the liquid crystal display comprises a liquid crystal panel, wherein the crystal panel is divided into a display section and a non-display section, the non-display section is disposed outside the display section, the non-display section surrounds the display section, the liquid crystal panel comprises a first substrate, a second substrate, a liquid crystal layer, and a light blocking layer. The second substrate is disposed opposite to the first substrate. The liquid crystal layer is clamped between the first substrate and the second substrate. The light blocking layer is disposed at the first substrate, wherein the light blocking layer is disposed at the narrow frame of the non-display section for preventing light leaking from the edge of the liquid crystal panel.

Wherein, the non-display section comprises a black matrix section, a terminal section and a non-terminal section. The terminal section is disposed at the section of the liquid crystal panel having a greater width. The black matrix section is disposed outside the display section. The black matrix section surrounds the display section. The rest section of the non-display section is the non-terminal section. The non-terminal section is the narrow frame of the liquid crystal panel.

Wherein, the light blocking layer is disposed at the non-terminal section of the non-display section.

Wherein, the second substrate comprises a clean glass section disposed at the section corresponding to the non-display section.

Wherein, the light blocking layer adopts the metallic layer 1 in the five photomask process of TFT.

Wherein, the light blocking layer adopts the metallic layer 2 in the five photomask process of TFT.

Wherein, the light blocking layer adopts a-Si, LTPS, or the metallic layer in the TFT process of IGZO technique.

Wherein, the light blocking layer adopts the thin film in the on cell touch technique.

Wherein, the light blocking layer is capable of protecting the liquid crystal panel from static electricity.

The technical features of the disclosure, which are distinguishable from the present technique, are that: the crystal panel is divided into a display section and a non-display section. The non-display section is disposed outside the display section, and the non-display section surrounds the display section. The liquid crystal panel comprises a first substrate, a second substrate, a liquid crystal layer, and a light blocking layer. The second substrate is disposed opposite to the first substrate. The liquid crystal layer is clamped between the first substrate and the second substrate. The light blocking layer is disposed at the first substrate, wherein the light blocking layer is disposed at the narrow frame of the non-display section for preventing light leaking from the edge of the liquid crystal panel. Therefore, the disclosure can prevent light leaking from the edge of the liquid crystal panel so that the visual quality is improved.

### BRIEF DESCRIPTION OF THE DRAWINGS

In order to explain the technical solutions of the disclosure more clearly, the brief description of the drawings for explanation of the embodiments is given as below. Apparently, the following drawings are merely some embodiments of the disclosure.

For those skilled in the art, the other drawings are attainable without creative endeavor according to these drawings, wherein:

FIG. 1 is the schematic diagram of the present liquid crystal panel; and

FIG. 2 is the schematic diagram of the liquid crystal panel of the embodiment according to the disclosure.

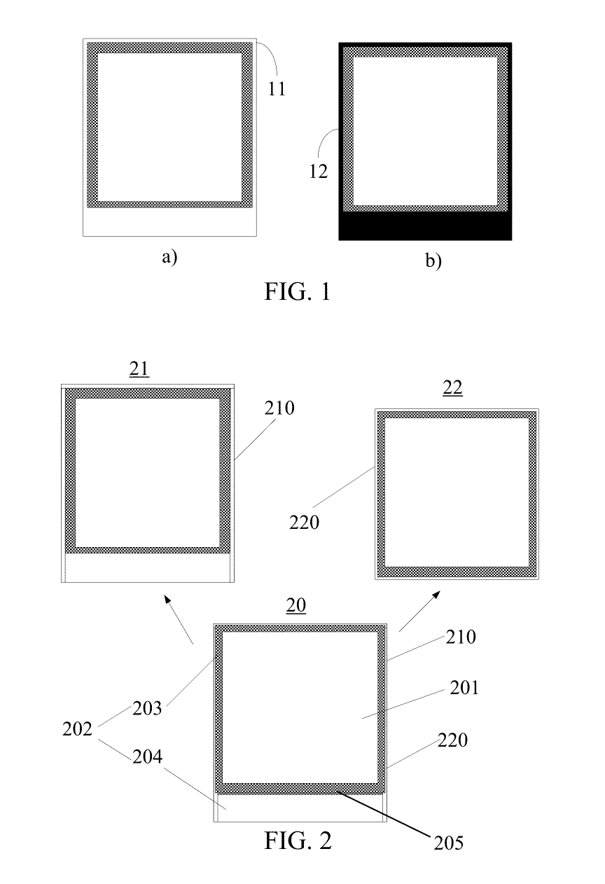

### DETAILED DESCRIPTION

The following description with reference to the accompanying drawings is provided to clearly and completely explain the exemplary embodiments of the disclosure. It is apparent that the following embodiments are merely some embodiments of the disclosure rather than all embodiments of the disclosure.

According to the embodiments in the disclosure, all the other embodiments attainable by those skilled in the art without creative endeavor belong to the protection scope of the disclosure.

Refer to FIG. 2, and FIG. 2 is the schematic diagram of the liquid crystal panel of the embodiment according to the disclosure. As shown in FIG. 2, a liquid crystal panel 20 is divided into a display section 201 and a non-display section 201. The non-display section 202 is disposed outside the display section 201, and the non-display section 202 surrounds the display section 201. The liquid crystal panel 20 comprises a first substrate 21, a second substrate 22, a liquid crystal layer (not shown), and a light blocking layer 210. The second substrate 22 is disposed opposite to the first substrate 21. The liquid crystal layer is clamped between the first substrate 21 and the second substrate 22. The light blocking layer 210 is disposed at the first substrate 21, wherein the light blocking layer 210 is disposed at the narrow frame of the non-display section 202 for preventing light leaking from the edge of the liquid crystal panel. Preferably, the first substrate 21 is an array substrate, and the second substrate 22 is a color filter (CF).

According to the embodiment of the disclosure, the non-display section 202 further comprises a black matrix section 205, a terminal section 204 and a non-terminal section 203. The black matrix section 205 is disposed outside the display section 201. The black matrix section 205 surrounds the display section 201. The terminal section 204 and the non-terminal section 203 are disposed outside the black matrix section 205, as well as the terminal section 204 and the non-terminal section 203 surround the black matrix section 205. The terminal section 204 is disposed at the section of the liquid crystal panel 20 having a greater width. The rest section of the non-display section 202 is the non-terminal section 20. The non-terminal section 203 is the narrow frame of the liquid crystal panel 20. The light blocking layer 210 is disposed at the non-terminal section 203 of the non-display section 202. The second substrate 22 comprises a clean glass section 220 disposed at the section corresponding to the non-display section 202. The opaque light blocking layer 210 is formed at the edge of the first substrate 21 so as to replace transparent clean glass structure. When the first substrate 21 bonds with second substrate 22, the light blocking layer 210, which is disposed at the first substrate, is capable of preventing the backlight passing through the clean glass structure, so as to prevent the problem of light leaking. Since the light blocking layer 210, which is made of metal, is light-reflective, so that the light blocking layer 210 does not interfere the examination for the accuracy of the periphery of LCD and the yield. Thus, it can fulfill the need of the current process that the frame of the liquid crystal panel 20 can be shortened for improving the visual effects while, at the meanwhile, preventing light leaking from the edge.

In more preferable embodiments, the light blocking layer 210 adopts the metallic layer existing in the process of manufacturing the first substrate 21, such as the metallic layer 1 and 2 in the five photomask process of TFT. However, the disclosure is not limited thereto. In other embodiments, the thin films or structures in other processes, which are light-reflective and opaque, can be used as the light blocking layer 210. For example, the light blocking layer 210 can adopt the metallic layer 1 in the five photomask process of TFT. Specifically, the light blocking layer 210 can be manufactured with the gate metallic layer at the same time. Alternatively, the light blocking layer 210 can adopt the metallic layer 2 in the five photomask process of TFT. Wherein, the metallic layer 2 is the ohmic contact layer contacting the source. Specifically, the light blocking layer 210 can adopt a-Si, LTPS (Low Temperature Poly-silicon), or the metallic layer in the TFT process of IGZO (indium gallium zinc oxide) technique. Specifically, the light blocking layer 210 can be each of the metallic layers described in the above TFT process. According to the embodiment of the disclosure, the light blocking layer 210 can also adopt the thin film in the on cell touch technique, which has a reflective and opaque thin film or structure.

In some other embodiments of the disclosure, when the opaque metallic layer is used at the side for the light blocking layer 210, the light blocking layer 210 can also achieve the effect of electro-static discharge (ESD). In the process of large version typesetting, the light blocking layer 210, which is used for electro-static discharging, can connect to each other or solely locates at each of the panel. Thus, the light blocking layer 210 is capable of protecting the liquid crystal panel 20 from static electricity.

According to another embodiment, the disclosure further provides a liquid crystal display. The liquid crystal display comprises the liquid crystal panel in FIG. 2, which is described above.

In summary, the disclosure provides a liquid crystal panel, wherein the crystal panel is divided into a display section and a non-display section. The non-display section is disposed outside the display section, and the non-display section surrounds the display section. The liquid crystal panel comprises a first substrate, a second substrate, a liquid crystal layer, and a light blocking layer. The second substrate is disposed opposite to the first substrate. The liquid crystal layer is clamped between the first substrate and the second substrate. The light blocking layer is disposed at the first substrate, wherein the light blocking layer is disposed at the narrow frame of the non-display section for preventing light leaking from the edge of the liquid crystal panel. Therefore, the disclosure can prevent light leaking from the edge of the liquid crystal panel so that the visual quality is improved.

Note that the specifications relating to the above embodiments should be construed as exemplary rather than as limitative of the present disclosure. The equivalent variations and modifications on the structures or the process by reference to the specification and the drawings of the disclosure, for example the combination of the technical features in each embodiment, and application to the other relevant technology fields directly or indirectly should be construed similarly as falling within the protection scope of the disclosure.

1. A liquid crystal panel, wherein the liquid crystal panel is divided into a display section and a non-display section, the non-display section is disposed outside the display section, the non-display section surrounds the display section, wherein the non-display section comprises a black matrix section, a terminal section and a non-terminal section, the terminal section is disposed at the section of the liquid crystal panel having a greater width, the black matrix section is disposed outside the display section, the black matrix section surrounds the display section, the rest section of the non-display section is the non-terminal section, which is a narrow frame, the liquid crystal panel comprises:
an array substrate;
a color filter substrate, disposed opposite to the array substrate, the color filter substrate comprises a clean glass section disposed at a section corresponding to the non-terminal section;
a liquid crystal layer, clamped between the array substrate and the color filter substrate; and
a light blocking layer, disposed at the non-terminal section of the array substrate, for preventing light leaking from the edge of the liquid crystal panel.

2˜4. (canceled)

5. The liquid crystal panel according to claim 1, wherein the light blocking layer adopts the metallic layer 1 in the five photomask process of TFT.

6. The liquid crystal panel according to claim 1, wherein the light blocking layer adopts the metallic layer 2 in the five photomask process of TFT.

7. The liquid crystal panel according to claim 6, wherein the light blocking layer adopts a-Si, LTPS, or the metallic layer in the TFT process of IGZO technique.

8. The liquid crystal panel according to claim 1, wherein the light blocking layer adopts the thin film in the on cell touch technique.

9. The liquid crystal panel according to claim 1, wherein the light blocking layer is capable of protecting the liquid crystal panel from static electricity.

10. A liquid crystal display, wherein the liquid crystal display comprises a liquid crystal panel, the liquid crystal panel is divided into a display section and a non-display section, the non-display section is disposed outside the display section, the non-display section surrounds the display section, wherein the non-display section comprises a black matrix section, a terminal section and a non-terminal section, the terminal section is disposed at the section of the liquid crystal panel having a greater width, the black matrix section is disposed outside the display section, the black matrix section surrounds the display section, the rest section of the non-display section is the non-terminal section, which is a narrow frame, the liquid crystal panel comprises:
an array substrate;
a color filter substrate, disposed opposite to the array substrate, the color filter substrate comprises a clean glass section disposed at a section corresponding to the non-terminal section;
a liquid crystal layer, clamped between the array substrate and the color filter substrate; and
a light blocking layer, disposed at the non-terminal section of the array substrate, for preventing light leaking from the edge of the liquid crystal panel.

11˜13. (canceled)

14. The liquid crystal display according to claim 10, wherein the light blocking layer adopts the metallic layer 1 in the five photomask process of TFT.

15. The liquid crystal display according to claim 10, wherein the light blocking layer adopts the metallic layer 2 in the five photomask process of TFT.

16. The liquid crystal display according to claim 15, wherein the light blocking layer adopts a-Si, LTPS, or the metallic layer in the TFT process of IGZO technique.

17. The liquid crystal display according to claim 10, wherein the light blocking layer adopts the thin film in the on cell touch technique.

18. The liquid crystal display according to claim 10, wherein the light blocking layer is capable of protecting the liquid crystal panel from static electricity.

19. The liquid crystal panel according to claim 1, wherein the non-terminal section is disposed outside the black matrix, the non-terminal section surrounds the black matrix.

20. The liquid crystal display according to claim 10, wherein the non-terminal section is disposed outside the black matrix, the non-terminal section surrounds the black matrix.
